(19) United States
(12) Patent Application Publication
(10) Pub. No.: US 2025/0077185 A1
(43) Pub. Date: Mar. 6, 2025

(54) STATISTICAL OUTPUT DISTRIBUTION MODULATION

(71) Applicant: Western Governors University, Salt Lake City, UT (US)

(72) Inventors: Brandon K. Vaughn, Leander, TX (US); Goran P. Trajkovski, Decatur, GA (US)

(21) Appl. No.: 18/820,078

(22) Filed: Aug. 29, 2024

Related U.S. Application Data
(60) Provisional application No. 63/535,673, filed on Aug. 31, 2023.

(51) Int. Cl. G06F 7/58

(52) U.S. Cl. CPC G06F 7/582

(57) ABSTRACT

Generating a unique dataset. A method includes obtaining one or more statistical output distributions. The method further includes obtaining a unique identifier for an entity. The method further includes using the unique identifier for the entity as a seed value to a pseudo random number generator, generating a numerical dataset having approximately the one or more statistical output distributions. The method further includes generating an output dataset by using the numerical dataset such that the output dataset produces the one or more statistical output distributions when statistically analyzed.

### CROSS-REFERENCE TO RELATED APPLICATIONS

This application claims the benefit of and priority to U.S. Provisional Patent Application Ser. No. 63/535,673 filed on Aug. 31, 2023 and entitled “Generating Standardized Data Sets for Use In Educational Competency Assessments,” and which application is expressly incorporated herein by reference in its entirety.

### BACKGROUND

There is often a need to use different datasets that are distinct in nature, but near identical in similarity of statistical distribution and trends when analyzed using the same analytical tools. Such datasets can be useful for testing and verification of the same or similar analytical computing systems. For example, in a Master of Science in Data Analytics program, the curriculum heavily emphasizes active-learning projects, also known as performance assessments where different students create different analytical computer systems. Consequently, there is a need to provide appropriate datasets for students to use in these assessments. Allowing students to select their own datasets presents several challenges. First, it requires evaluators to prepare for the analysis of potentially different datasets for each student, which complicates the evaluation process. Additionally, the variability in data complexity can lead to unequal assessment conditions, making it difficult to ensure fairness across student evaluations. Students choosing their own data may not necessarily pick datasets of comparable difficulty. One student might select a dataset that is considerably easier to analyze than that chosen by another student. This lack of standardization in data selection can compromise the accuracy of competency assessments, as it fails to uniformly challenge and support all students. Furthermore, there is a risk that a student may choose an inadequate dataset that lacks the necessary variables and statistical trends for specific analyses required in their course. Unaware of these shortcomings, a student could waste significant time struggling with their analyses, not realizing that their chosen data is the primary issue.

For curriculum developers, selecting existing datasets introduces significant challenges. One major issue is the difficulty of ensuring that the datasets are secure, accessible, and consistent across various educational contexts. First, it is challenging to find unique datasets that are open-source and free to use. Second, the chosen datasets must be versatile enough to be used across different and consecutive classes, each with diverse analytical requirements such as regression, classification, and clustering. This demands that the datasets be both flexible and comprehensive. Moreover, different datasets can vary significantly in terms of analysis complexity. For example, one dataset might have more rows of data or a higher number of missing values and outliers than another. These differences can lead to inconsistencies in learning outcomes and may skew competency assessments. As a result, students may quickly identify and disseminate information via social media about which datasets are easier to analyze, creating an unfair advantage. Additionally, if a student shares their answers online and compromises the exam, it becomes necessary to quickly find a new dataset to replace the compromised one.

Further, some datasets are incredibly complex with 10,000 or more rows of data. Thus, different datasets may have drastically different variability such that it is difficult to normalize characteristics of the datasets and to normalize statistical analysis of the datasets so as to compare complexity and/or correctness of analysis of the datasets.

Given these challenges, traditional methods of sourcing data are inadequate due to the complexities involved in maintaining fairness, relevance, and integrity in the datasets. Instead, there is a need for a system that can generate complex and standardized, yet distinct, datasets.

The subject matter claimed in this application is not confined to embodiments that address only the disadvantages or operate exclusively in the environments described above. Instead, this background is provided merely to illustrate one example of a technology area where some embodiments of the invention may be applied.

### BRIEF SUMMARY

In some embodiments, a method of modulating datasets is implemented. The method includes obtaining a plurality of unique identifiers each corresponding to an entity in a plurality of entities. The method further includes using the unique identifiers for the entities as seed values to a pseudo random number generator, generate a plurality of different numerical dataset having different values, but each having approximately the one or more statistical output distributions. The method further includes generating output datasets by using the numerical datasets such that the output datasets produce approximately the one or more statistical output distributions when statistically analyzed.

This summary introduces a selection of concepts in a simplified form that are further elaborated upon in the detailed description below. It includes technical details on data generation processes, statistical modeling techniques, and the implementation of robust computing rules for creating datasets. This summary is not intended to identify key features or essential aspects of the claimed subject matter, nor should it be used to determine the scope of the claimed subject matter.

Additional features and advantages will be detailed in the subsequent description. Some of these will become apparent from the description itself, or they may be learned through practicing the teachings provided herein. The features and advantages of the invention may be realized and obtained by means of the elements and combinations particularly pointed out in the appended claims. These features will become more evident from the following description and the appended claims or may be learned by practicing the invention as described.

### BRIEF DESCRIPTION OF THE DRAWINGS

In order to detail how the advantages and features mentioned above can be achieved, a more specific description of the subject matter is provided with reference to particular embodiments illustrated in the accompanying drawings. It is important to note that these drawings depict typical embodiments and should not be considered as limiting the scope of the invention. Additional specificity and detail are provided in the following sections with the use of these drawings to better explain the embodiments.

FIG. 1 illustrates an environment where various embodiments of the invention can be implemented;

FIG. 2 illustrates an environment where various embodiments of the invention can be implemented;

FIG. 3 illustrates an example process flow of the dataset generation system;

FIG. 4 illustrates an example process flow of the dataset generation system; and

FIG. 5 illustrates an example process flow of the dataset generation system.

### DETAILED DESCRIPTION

Some embodiments illustrated herein facilitate the easy generation of large, complex datasets that are adaptable for different uses. In some embodiments, different datasets can be generated to each have consistent characteristics. For example, different datasets can have the same or a similar number of rows. Alternatively, or additionally, datasets can have the same or similar types of variables. Alternatively, or additionally, datasets can have the same or similar numbers of outliers. Alternatively, or additionally, datasets can have the same or similar types of levels of missing data. When different datasets are used in an educational environment, embodiments can ensure a uniform structure and controlled variability so as to maintain educational and psychometric equality.

Some embodiments can be implemented for use in online platforms. As such, some advanced data generation systems produce secure, scalable, and adaptable datasets tailored to meet a variety of requirements. Systems can be configured to ensure that online education remains effective and equitable across diverse learning contexts.

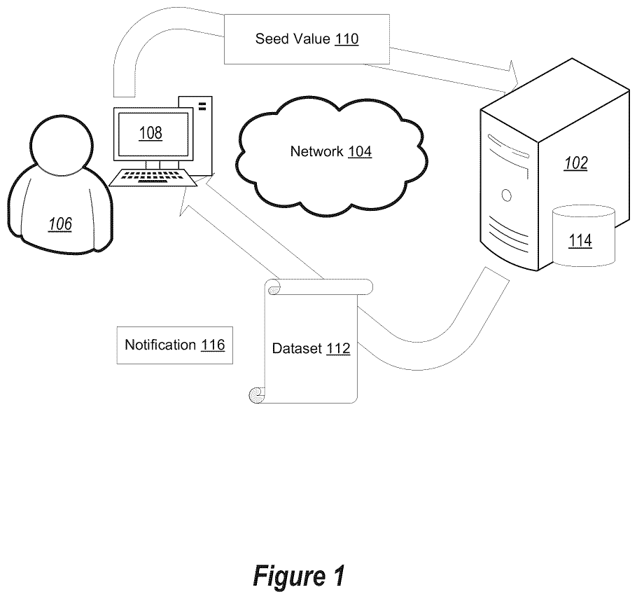

FIG. 1 illustrates an example environment where one embodiment of the dataset generation system can be implemented. In this example, a data generator 102 provides remote access over a network 104, allowing a user 106, such as a student, to input a unique seed value 110 at a computing system 108.

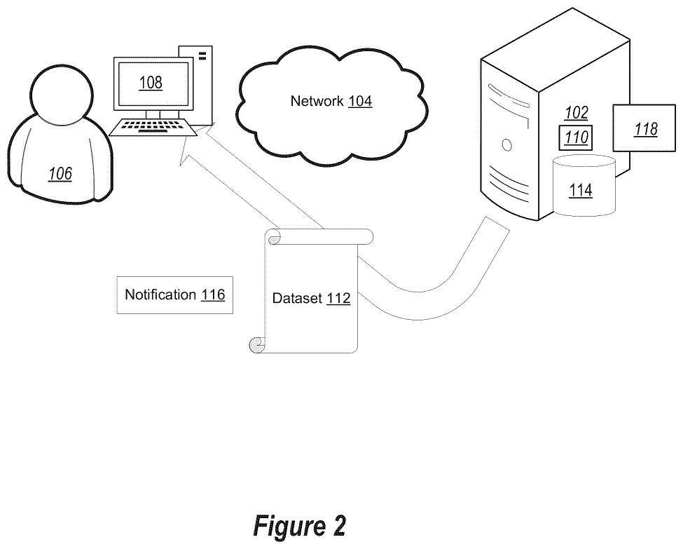

In alternative embodiments, as illustrated in FIG. 2, a seed value 110 can be generated at a seed value generator 118 at the data generator 102. In one embodiment, the seed value 110 can be a time value. For example, the time value can be a time stamp of when a dataset 112 is requested, when a dataset 112 is generated, or some other time stamp value. In one such embodiment a seed value generated at the seed value generator 118 can be generated using a clock value at the data generator 102.

This seed value 110 is used to generate a personalized, but standardized, dataset 112. The system ensures that each dataset is unique, but similar to other dataset when statistically analyzed, such as by regression, classification, and/or clustering operations. In some embodiments, the system ensures that the dataset 112 is unique to a particular user 106 and can be consistently regenerated if needed. This capability is particularly valuable for reassessment scenarios or when additional data analysis is required. The use of a unique seed value, such as a student ID, avoids collisions and enables the generation of distinct datasets for each user 106, ensuring personalized data scenarios while maintaining a controlled environment for assessments. Additionally, this setup allows for reproducibility, enabling the same random numbers (or ultimately other data) to be generated each time for consistent dataset replication. Specifically, using a student's ID as a seed value allows for the initialization of a pseudo-random number generator (PRNG) like the Mersenne Twister or Linear Congruential Generator (LCG). These generators are chosen for their efficiency in producing high-quality random sequences that are statistically independent, which is used for ensuring the uniqueness and integrity of each dataset. Note that in embodiments where a clock values or other values are used, embodiments can store, such as in the database 114, a correlation between the clock value and a user 106 or other entity for which the dataset 112 is being generated.

The data generator 102, using the seed value, employs a pseudo-random number generator (PRNG) to generate a standardized dataset 112 that complies with a set of predetermined conditions suitable for their intended purpose. For example, the pseudo-random number generator can be able to generate a numerical dataset having a particular distribution or other characteristic. The numerical dataset can then be used to create the dataset 112 as an output dataset. In some embodiments, this creates datasets suitable for educational data analytics competency assessments. PRNGs such as the Mersenne Twister and Linear Congruential Generator (LCG) are selected for their ability to produce high-quality random sequences with desirable statistical properties, such as uniform distribution and long periods. The Mersenne Twister is particularly noted for its extremely long period of 219937-1, ensuring that the generated sequences do not repeat for a very large number of iterations, which is used for maintaining the integrity and uniqueness of the datasets. The LCG, valued for its computational simplicity and speed, is useful for generating large datasets quickly. These PRNGs convert the seed value into a sequence of pseudo-random numbers that are used to generate data points adhering to specific statistical distributions. This approach ensures that each number generated is statistically independent, a key factor in maintaining a dataset's integrity and usefulness for educational assessments. The choice of PRNG and the method of seed initialization are selected for ensuring that the datasets are consistent, reproducible, and meet the educational standards.

The data generator 102 tests the generated dataset 112 using one or more data analytics processes to ensure it meets the necessary criteria for use in educational data analytics competency assessments. These processes involve validating the dataset's characteristics, such as its adherence to specified statistical distributions and its ability to support various analytical techniques, including regression, classification, and clustering. The testing phase ensures that the dataset 112 is comprehensive, reliable, and suitable for the intended educational purposes. Any dataset that fails to meet the standards is either adjusted or regenerated to align with the assessment requirements.

The data generator 102 stores the validated dataset 112 in a centralized database 114 that contains a collection of datasets for different users. This database 114 is designed to maintain data integrity and security, ensuring that each dataset is accessible for future educational use and reassessment. By storing the datasets centrally, the system facilitates easy retrieval and management, allowing for efficient access and distribution of datasets to users as needed for their coursework and competency assessments.

As a result of the datasets being stored in the database 114, the data generator 102 sends a notification 116 to the user 106 associated with the unique seed value, informing them that their dataset 112 is available for use. This notification 116 is transmitted over the network and ensures that the user 106 is promptly aware of the dataset's availability for their data analytics competency assessment. The notification 116 includes details on how to access the dataset 112 and any instructions necessary for its use in their coursework. This process facilitates seamless communication and ensures that users can efficiently access the resources they need for their educational activities.

The database 114 receives a request from the user 106 for the dataset 112. This request is typically made through the educational platform's interface, where the user 106 inputs identifying information, such as a student ID, to access the specific dataset 112 generated for them. The system verifies the user's credentials and matches the request with the corresponding dataset 112 stored in the centralized database 114. This ensures that the dataset retrieval process is secure and that users receive the correct data associated with their unique seed value, supporting personalized learning and accurate assessments.

Upon receiving the request, the database 114 sends the dataset 112 over the network 104 to the user 106, ensuring they have access to the data for completing their competency assessment. The dataset 112 is delivered in a format that is easy to use and compatible with the tools and software the users are expected to utilize in their coursework. This process ensures that users can readily analyze the data and complete their assignments, supporting a seamless integration of the dataset 112 into their educational activities.

The networked system plays a role in the modern educational landscape, where much of the learning is conducted online. This system enables users to access courses stored on servers and engage with professors and peers through online interactions. By integrating the data generation and distribution process into this networked environment, the system ensures that datasets are easily accessible and can be efficiently shared and managed. This integration is used for supporting scalable and flexible online learning platforms, facilitating effective educational experiences in a digital context.

The following discussion refers to various methods and actions that can be performed as part of the dataset generation and management process. Although these methods and actions can be described or illustrated in a specific order, no particular sequence is required unless explicitly stated or necessary due to dependencies between actions. The steps outlined can be performed independently or in combination, depending on the specific requirements of the educational context and the goals of the assessment.

In some embodiments, a dataset generator creates datasets for use across multiple courses in data analytics and statistics. This generator produces datasets with a specified number of rows and allows for randomization using a student's ID as a seed value, ensuring that each dataset is unique to the user. The datasets include a variety of simulated data such as demographic information—examples include job type, location, zip code, and number of children. These demographic variables are generated using statistical distributions like normal, binomial, and uniform distributions to accurately reflect real-world demographic patterns. The data is modeled after real industry datasets, such as those used to track customer churn or hospital patient readmissions, capturing trends and variability relevant to educational scenarios. These datasets are versatile enough to be used in a wide range of academic programs, from basic statistics and data mining to regression modeling. The generator is designed to be easily customized for various topics across different industries, including supply chain, logistics, finance, and military applications. This adaptability ensures that the datasets can be tailored to meet specific educational and analytical needs.

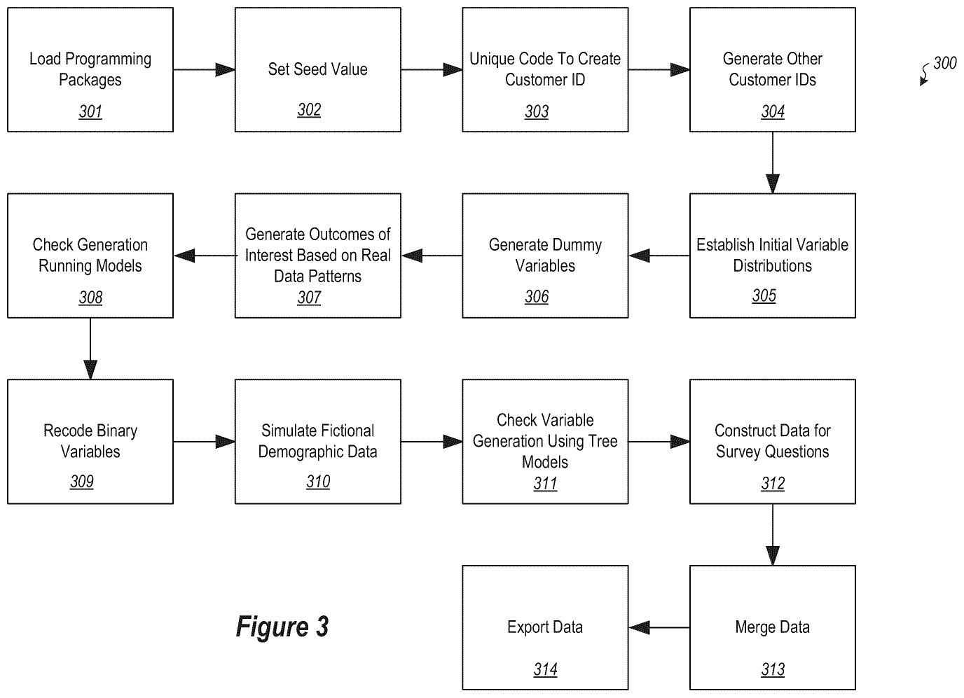

Referring now to FIG. 3, one method 300 is illustrated for generating and validating datasets to ensure they meet specific requirements. This method ensures that the generated datasets not only meet the number of rows but also maintain statistical integrity across demographic and industry-specific variables. Each step in the process, from data generation to validation, is designed to create datasets that are both accurate and useful for desired purposes, supporting various analytical techniques and competency assessments.

In some embodiments, the dataset generator utilizes both existing libraries, such as those in the software environment for statistical computing and graphics, R, available from The R Foundation, and custom code to create the datasets. In an embodiment where R is used, the existing libraries, which are loaded (act 301) initially, include a variety of tools for generating different types of data, such as:
IDs—used to simulate Customer IDs
Mice—used to simulate Missing Data patterns
Salty—used to “mess up” data
Chariatan—used to create some fictional demographic data
Wakefield—used to create other fictional demographic data
Zipcode—used to simulate fictional zip codes
Rpart—used to run tree models to test generated data
Truncnorm—used to generate random variables from a truncated normal distribution

These libraries ensure that each dataset adheres to specific characteristics, such as a fixed number of rows and consistent data distributions, by standardizing the datasets and maintaining the balance of outliers and handling missing values appropriately. For example, the Mice library helps simulate realistic patterns of missing data, while the Truncnorm library ensures that generated random variables stay within desired limits, maintaining the dataset's statistical integrity. The use of these libraries supports the generation of robust and educationally valuable datasets that accurately represent real-world data scenarios.

The generation of random variables is controlled by setting a seed value (act 302), which is used for ensuring reproducibility. By using a student's ID as the seed value, the system guarantees that each dataset is unique to the user. Other seed values unique to a user can alternatively be used. This ensures that the same dataset can be regenerated if needed, which is particularly useful for reassessment or verification purposes. The seed value locks the random variable generation, allowing the same dataset to be reproduced in subsequent runs. For instance, specifying a seed value enables consistent results in simulations and analyses, making it possible to maintain uniformity in educational assessments while still providing individualized datasets for each user 106. The specified number of rows for each dataset, such as 10 rows, is also determined at this stage, ensuring that every dataset meets the size and structure for analysis.

The primary identifier for each individual in the dataset is generated using an ID generator (act 303). This unique identifier serves as the main ID to distinguish each fictional person within the dataset. One of its applications is in creating structured data that can be organized into SQL tables, where the main ID links records across multiple tables, facilitating comprehensive data analysis and manipulation. This standardized approach to ID generation ensures that each dataset maintains consistency and is easily integrated into various database systems, supporting complex queries and enhancing the data's educational utility.

Additional unique identifiers, or customer IDs, are generated (act 304) using the same or similar methods as the primary ID created in at 303. These secondary IDs serve as backup identifiers to support data integrity and redundancy, ensuring that if any issues arise with the primary ID, the dataset remains robust and reliable. These additional IDs also facilitate cross-referencing and linking of data points across different tables or datasets, enhancing the ability to perform complex data analysis and ensuring that a given data structure is resilient to inconsistencies.

Initial variables in the dataset are defined according to specific distributional patterns (act 305) based on research and real-world data. For instance, in a dataset simulating telecommunications customer churn, variables might include contract type, gender, service subscribed, and payment method. Each variable is generated to mirror real data patterns, such as contract type being distributed across month-to-month, one-year, and two-year options, following observed proportions (e.g., month-to-month at 55%, one-year at 21%, and two-year at 24%). These proportions ensure that the generated datasets accurately reflect the characteristics and variability seen in real datasets, providing a realistic foundation for analysis in educational settings.

To facilitate data analysis, categorical variables are converted into dummy variables (act 306). For example, a contract variable with categories such as “month-to-month,” “one-year,” and “two-year” is transformed into binary dummy variables for each category (e.g., a “one-year” contract might be represented as 0 for “month-to-month” and “two-year,” and 1 for “one-year”). This conversion allows for easier incorporation into statistical models and analysis techniques, ensuring that categorical data can be effectively used in regression and other analytical methods. By transforming categorical variables into dummy variables, the dataset becomes more versatile and capable of supporting a wide range of statistical analyses in educational settings.

Additional variables, which serve as outcome variables for specific models in various classes, are generated (act 307). For example, in many courses, a binary outcome variable such as customer churn (whether a customer has left the company) is needed for logistic regression or classification tree analysis. This variable is generated to reflect real-world patterns by simulating the correlations between predictor variables and the outcome variable. For instance, in a telecommunications dataset, the likelihood of customer churn might be correlated with factors such as contract length, monthly charges, and customer service interactions. These outcome variables are created to mirror the relationships seen in actual data, providing realistic scenarios for students to analyze in their coursework.

Once the predictor and outcome variables have been generated, various statistical models, such as regression and classification models, are run (act 308) to verify that the distributional and correlational patterns in the dataset reflect those found in real data. In one embodiment, if the data fails to meet the expected standards in these modeling tests, it is discarded, and new data is generated. This validation process includes checking the consistency of variable relationships and ensuring that the dataset maintains statistical integrity. For instance, regression models might be used to test the strength and direction of relationships between predictors and the outcome variable, while classification models assess the accuracy of categorical predictions. If anomalies or inconsistencies are detected, adjustments are made to the data generation process, including modifications to the seed value or underlying statistical assumptions, to produce a new dataset that meets the criteria for educational use. The modified seed value and/or modified underlying statistical assumptions can be saved to used in subsequent dataset generation to ensure that a given dataset can be reproduced. Alternatively, standardized modifications can iteratively be used until a compliant dataset is produced so that the same modifications can be later iteratively applied to obtain the same dataset.

To prepare the data for student use, binary variables generated during the dataset creation process are converted back into their categorical forms (act 309). For example, a binary variable indicating senior status might be converted from 0 and 1 to “no” and “yes.” This conversion ensures that the data is in an intuitive and user-friendly format that students can easily interpret and analyze during their coursework. By transforming binary variables into categorical labels, the dataset becomes more accessible and understandable, facilitating effective learning and analysis in educational contexts.

Various demographic data points, such as zip code, age, number of children, and income, are randomly generated for each individual in the dataset (act 310). This step ensures that the dataset includes comprehensive demographic information that is relevant to the scenarios being analyzed. In some embodiments, different R packages, such as Charlatan and Wakefield, are utilized to generate these demographic variables, ensuring they reflect realistic distributions and patterns. By incorporating a diverse range of demographic data, the dataset provides a robust foundation for various types of analysis, from statistical modeling to machine learning applications, supporting a wide range of educational objectives.

After the demographic data is generated, the dataset undergoes another round of analysis (act 311) using different statistical models, such as regression trees and clustering algorithms. This analysis ensures that the demographic variables, along with the previously generated data, are consistent and realistic. Any anomalies or irregular patterns identified during this step prompt a review and adjustment of the demographic data generation process. These adjustments are made to align the dataset with expected patterns and standards, ensuring that it meets the criteria for educational purposes. The process of analysis and adjustment is repeated iteratively until the dataset is validated and confirmed to be functional for the intended educational applications.

Embodiments further optionally include creating “survey data,” (act 312) which will be used in some courses for data reduction techniques, such as principal component analysis (PCA) and factor analysis. In some embodiments, ten survey questions are generated, with the variables constructed to represent three unique factors among the questions. These variables are designed to follow a traditional 5-point Likert scale (or similar), providing a range of responses from strongly disagree to strongly agree. The responses for each individual in the dataset are generated to ensure they reflect realistic patterns and variability, providing students with practical experience in analyzing survey data and applying advanced statistical techniques.

The final output dataset is assembled by combining the variables generated in the previous steps (act 313), including demographic data, predictor and outcome variables, and/or survey responses. This comprehensive dataset is reviewed to ensure it meets the standards for completeness, accuracy, and relevance to the educational objectives. The process includes verifying the consistency and integrity of the data, ensuring that it is suitable for the intended analysis and educational use. Once confirmed, the dataset is prepared for export in formats such as CSV or other compatible file types, ready for deployment in educational courses and assessments.

The dataset is exported (act 314) into a file format such as CSV or other appropriate formats that can be easily integrated into educational platforms for student use. This export process ensures that the dataset is accessible and ready for deployment in various courses, supporting a wide range of educational activities, from basic statistical analysis to complex data mining tasks. The dataset is organized and formatted to facilitate seamless integration with learning management systems and analytical tools, ensuring that students can readily access and use the data for their coursework and competency assessments.

These acts are repeated for other industry-specific topics for which a dataset needs to be generated, such as telecommunications customer churn, hospital patient readmission, and other contexts where a diverse, standardized data is required. If a dataset needs to be regenerated due to anomalies detected or compromised data integrity, the process involves using the existing saved code for that specific topic. The regeneration process includes identifying and addressing issues such as unexpected data patterns, outliers, or data inconsistencies. This is done by generating a new seed value and creating a new dataset that is distinct from the compromised one. For instance, if an anomaly is detected, the seed value might be adjusted by appending an anomaly counter or creating a hash of the original seed value to ensure the new dataset is unique and free from the issues identified in the original. This approach ensures that any dataset anomalies, such as data leaks or integrity breaches, are corrected. Comprehensive checks, including statistical validations and integrity assessments, are conducted to ensure that the regenerated datasets meet specified criteria. These checks verify that the new dataset aligns with the original requirements and maintains the standards necessary for educational use, ensuring that it is fit for purpose and adheres to the expected educational and analytical standards.

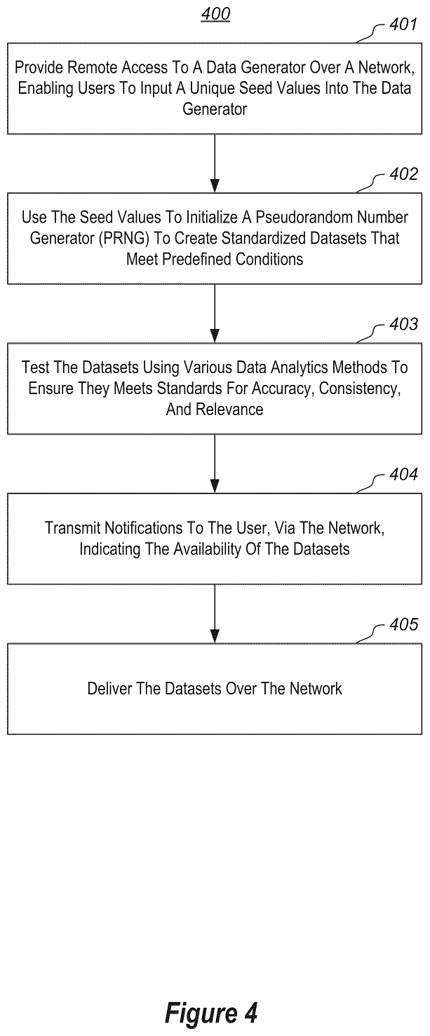

In another example illustrated in FIG. 4, a method 400 includes providing remote access to a data generator over a network (act 401). This enables users to input unique seed values into the data generator, where the seed value is associated with a specific student. The method includes using the seed value to initialize a pseudorandom number generator (PRNG) to create a standardized dataset that meets predefined conditions (act 402). The conditions cause the standardized dataset to be suitable for educational data analytics competency assessments. The dataset is tested using various data analytics methods to ensure it meets the standards for accuracy, consistency, and relevance (act 403), such as for educational purposes. The generated dataset is then stored in a centralized database, which maintains datasets for multiple students, ensuring secure and organized data management. A notification is transmitted to the user, via the network, indicating the availability of the dataset (act 404), such as for their data analytics competency assessment. Upon receiving a request from the user, the dataset is delivered over the network (act 405), allowing the user to analyze the data and complete their educational assessment.

In some embodiments, the unique seed value is derived from a student ID, ensuring that each generated dataset is unique to the individual student. This approach not only personalizes the data but also facilitates reproducibility, allowing the exact dataset to be regenerated if needed, which is particularly useful for reassessment or verification purposes.

In some embodiments, generating the standardized dataset involves the use of a pseudorandom number generator (PRNG) that produces a sequence of pseudorandom numbers. These numbers are then converted into categorical standard values, ensuring that the dataset adheres to specific statistical properties and maintains consistency across different datasets.

In some embodiments, generating the standardized dataset is based on distributional patterns identified in real-world datasets. This ensures that the generated data accurately reflects real-world scenarios, providing a realistic foundation for educational analysis and competency assessments.

In some embodiments, generating the standardized dataset involves creating predictor variables that reflect patterns observed in real-world datasets. This ensures that the generated data captures the trends and relationships needed for accurate and meaningful educational assessments.

In some embodiments, generating the standardized dataset includes creating outcome variables that maintain correlational patterns with predictor variables seen in real-world datasets. This ensures that the generated data realistically mirrors the relationships found in actual data, providing a reliable basis for educational analysis.

In some embodiments, generating the standardized dataset includes simulating random demographic variables for individuals. This ensures that the dataset captures realistic population characteristics and variability, providing a robust foundation for educational data analysis and competency assessments.

In some embodiments, generating the standardized dataset is part of a process that maps generated variables to various industry topics, allowing for the creation of datasets tailored to specific educational and analytical needs. This adaptability ensures that the datasets are relevant to different fields, such as supply chain, finance, healthcare, and others, thereby enhancing their applicability and value in educational contexts.

In some embodiments, inconsistency in the dataset is purposefully added to enable student testing of “messy” data.

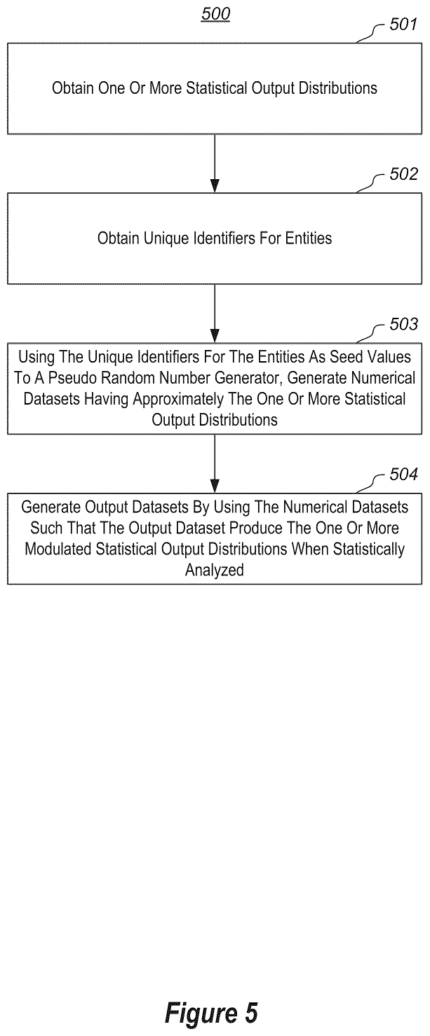

Referring now to FIG. 5, a method 500 of modulating datasets is illustrated. The method includes obtaining one or more statistical output distributions (act 501). For example, statistical output distributions can be obtained by analyzing real world data as discussed above.

The method 500 further includes obtaining unique identifiers for entities (act 502). For example, as discussed above, a student ID can be obtained. Alternatively, a timestamp or clock value associated with the entity can be used. Other unique identifiers can be alternatively or additionally used.

The method 500 further includes using the unique identifiers for the entities as a seed value to a pseudo random number generator, generating numerical datasets having approximately the one or more statistical output distributions (act 503). Note that the datasets can not have exactly the same distributions as the statistical output distributions due to intentional variability, but nonetheless, the datasets will have distributions very close to the statistical output distributions. For example, the distribution can vary by less than 1% from the statistical output distributions. Alternatively, the distributions can vary by less than 5%. Alternatively, the distributions can vary by less than 10%. Alternatively, the distributions can vary by less than 20%.

The method 500 further includes generating output datasets by using the numerical datasets such that the output datasets produce approximately the one or more statistical output distributions when statistically analyzed (act 504). In this way, the method 500 can produce datasets to users with distributions modulated by unique identifiers.

The method 500 can be practiced where generating the output datasets comprises generating data elements in the output datasets in a fashion to ensure at least one of consistency, statistical correlation, or plausibility between related elements.

The method 500 can be practiced where generating the output datasets comprises generating data elements in the output datasets in a fashion to ensure that the data elements do not correspond to actual real world data elements. For example, embodiments can generate addresses that are plausible, but do not actually exist. For example, a house number for an actual street can be generated where the street number does not correspond to an actual house number.

The method 500 can be practiced where generating the output datasets comprises generating data elements in the output datasets in a fashion to ensure a predetermined amount of inconsistent data is included in the datasets. That is, inconsistencies can be intentionally added to data, in a standardized way such that all datasets have similar inconsistencies, so as to be able to evaluate a student, using a statistical analysis system, and their ability to identify inconsistencies.

The methods and processes can be implemented to ensure that the datasets generated are robust, accurate, and suitable for educational use, supporting a wide range of analytical tasks and learning objectives. The ability to simulate realistic data and create standardized datasets tailored to various industry contexts provides a valuable tool for educators and students, facilitating effective learning and assessment in data-driven disciplines.

Further, the methods described herein can be implemented by a computer system that includes one or more processors and computer-readable media, such as computer memory. This memory stores computer-executable instructions that, when executed by the processors, perform the various functions and actions described in the embodiments. The computer-readable media can be any available media that can store and carry instructions or data structures, enabling the performance of specified functions by a general-purpose or special-purpose computer system. This includes physical storage media such as RAM, ROM, EEPROM, CD-ROM, DVDs, magnetic disk storage, or any other medium that can store desired program code means in the form of computer-executable instructions or data structures and which can be accessed by a computer.

Embodiments of the present invention can utilize a special-purpose or general-purpose computer that includes computer hardware, as detailed in the previous sections. This computer hardware includes components such as processors and computer-readable media. Embodiments within the scope of the present invention also include physical and other computer-readable media for carrying or storing computer-executable instructions and/or data structures. These media enable the implementation of the functions described herein, facilitating the execution of the methods and processes by the computer system. The media can be accessed by various types of computer systems, including personal computers, desktops, laptops, and other specialized computing devices, ensuring that the invention can be deployed across a wide range of platforms and configurations.

Physical computer-readable storage media include a wide range of data storage options, such as RAM (Random Access Memory), ROM (Read-Only Memory), EEPROM (Electrically Erasable Programmable Read-Only Memory), CD-ROMs, DVDs, magnetic disk storage, and other magnetic storage devices. These media can store program code and data structures, enabling a computer to perform specific functions or execute applications. Any medium that can be accessed by a computer for storing or retrieving data falls under this category.

A “network” is defined as one or more data links that facilitate the transport of electronic data between computer systems, modules, or other electronic devices. Networks can include hardwired connections, wireless connections, or a combination of both. When data is transferred over a network, the connection is viewed as a transmission medium that can carry computer-executable instructions, data structures, or other forms of data. This broad definition encompasses local area networks (LANs), wide area networks (WANs), and other configurations that enable data communication between computers. Transmission media are integral to the operation of distributed computing environments, where data and instructions must be shared across multiple systems to perform complex functions and support the described methods and processes.

Upon reaching various computer system components, program code and data structures can be automatically transferred from transmission media to physical storage media and vice versa. For example, computer-executable instructions or data received over a network can be temporarily buffered in RAM within a network interface module (such as a NIC-Network Interface Card) and then transferred to the main system RAM or more permanent storage like a hard drive or SSD. This process enables the seamless transition of data between transmission media and storage media, ensuring that data is readily accessible and can be stored or retrieved as needed. The integration of transmission and physical storage media is used for maintaining data flow and supporting the operational needs of complex computing systems.

Computer-executable instructions consist of commands that enable a general-purpose or special-purpose computer, or a specialized processing device, to perform specific tasks or functions. These instructions can be in various forms, such as binary code, intermediate code (like assembly language), or even high-level source code. They are designed to be executed by the computer's processor(s) to carry out the desired operations. The instructions may include algorithms, data processing routines, and other software components that facilitate the execution of the methods and processes described in this document. By providing detailed and structured instructions, these computer-executable commands ensure that the computer system operates efficiently and effectively to implement the invention's functionalities.

Those skilled in the art will appreciate that the invention can be practiced in network computing environments that encompass a wide range of computer system configurations, including but not limited to personal computers, desktops, laptops, servers, handheld devices, multi-processor systems, and microprocessor-based or programmable consumer electronics. The invention is also adaptable to various distributed systems, where local and remote computer systems, linked via networks (both wired and wireless), collaborate to perform complex tasks. Program modules and data can be distributed across different memory storage devices within this network, supporting the coordinated execution of processes. This versatility ensures that the methods and systems described herein can be implemented across a broad spectrum of computing environments, facilitating robust and scalable solutions.

Alternatively, or in addition, the functionalities described herein can be executed, at least in part, by hardware logic components. Examples of such hardware logic components include, but are not limited to, Field-Programmable Gate Arrays (FPGAs), Application-Specific Integrated Circuits (ASICs), Application-Specific Standard Products (ASSPs), System-on-a-Chip (SoC) systems, and Complex Programmable Logic Devices (CPLDs). These hardware components can be programmed or configured to perform specific functions, enabling the efficient execution of the methods and processes described in this document. By leveraging hardware-based implementations, the invention can achieve higher performance, lower latency, and greater energy efficiency, making it suitable for high-demand and resource-constrained applications.

The present invention may be embodied in other specific forms without departing from its essential characteristics. The described embodiments are meant to be illustrative and not restrictive. The scope of the invention is defined by the claims rather than by the foregoing description. All modifications, equivalents, and changes that fall within the meaning and range of the claims are intended to be embraced within their scope. This flexibility ensures that the invention can be adapted and applied to various contexts and requirements, allowing for diverse implementations while maintaining its core principles and benefits.

What is claimed is:

1. A method of modulating datasets, the method comprising:
obtain one or more statistical output distributions;
obtain a plurality of unique identifiers each corresponding to an entity in a plurality of entities;
using the unique identifiers for the entities as seed values to a pseudo random number generator, generate a plurality of different numerical dataset having different values, but each having approximately the one or more statistical output distributions; and
generate output datasets by using the numerical datasets such that the output datasets produce approximately the one or more statistical output distributions when statistically analyzed.

2. The method of claim 1, wherein generating the output datasets comprises generating data elements in the output datasets in a fashion to ensure at least one of consistency, statistical correlation, or plausibility between related elements.

3. The method of claim 1, wherein generating the output datasets comprises generating data elements in the output dataset in a fashion to ensure that the data elements do not correspond to actual real world data elements.

4. The method of claim 1, wherein generating the output datasets comprises generating data elements in the output datasets in a fashion to ensure a predetermined amount of inconsistent data is included in the datasets.

5. The method of claim 1, wherein the unique identifiers comprise student IDs.

6. The method of claim 1, wherein the unique identifiers comprise a time stamp.

7. A method comprising:
providing remote access to a data generator over a network so that users can provide unique seed values to the data generator, wherein the unique seed values are correlated at the data generator to a particular entity;
using the seed values, using a pseudorandom generator to generate standardized datasets complying with a plurality of predetermined conditions for a data analytics assessment;
testing the datasets using one or more data analytics processes to ensure the dataset is able to be used in a data analytics assessment;
storing the datasets in a database comprising a collection of datasets for different entities;
as a result of the datasets being stored in the database, transmitting a notification to the entities, over the network, correlated with the unique seed values that the dataset are available for the data analytics assessment;
receiving a request from the entities for the datasets;
sending the datasets over the network to the entities to allow the entities to analyze the data to complete the data analytics assessment.

8. The method of claim 7, wherein the unique seed value comprises a student ID.

9. The method of claim 7, wherein generating the standardized datasets comprises the pseudorandom generator generating pseudorandom numbers and converting the pseudorandom numbers to categorical standard values.

10. The method of claim 7, wherein generating the standardized datasets comprises generating the standardized datasets based on distributional patterns identified in real world datasets.

11. The method of claim 7, wherein generating the standardized datasets comprises generating the standardized datasets based on predictor variables seen in real world datasets.

12. The method of claim 7, wherein generating the standardized datasets comprises generating the standardized datasets based on correlation patterns with predictor variables in real world datasets.

13. The method of claim 7, wherein generating the standardized datasets comprises generating random demographic variables for simulated individuals.

14. The method of claim 7, wherein generating the standardized datasets is performed as part of a process of mapping generated variables to a plurality of industry topics.

15. A computing system for generating a unique dataset, the computing system comprising:
an interface for obtaining one or more statistical output distributions;
an interface for obtaining unique identifiers for entities;
a pseudo random number generator that uses the unique identifiers for the entities as a seed value to generate numerical datasets having approximately the one or more statistical output distributions; and
an output data generator configured to generate output datasets by using the numerical datasets such that the output datasets produce approximately the one or more statistical output distributions when statistically analyzed.

16. The computing system of claim 15, wherein generating the output datasets comprises generating data elements in the output datasets in a fashion to ensure at least one of consistency, statistical correlation, or plausibility between related elements.

17. The computing system of claim 15, wherein generating the output datasets comprises generating data elements in the output datasets in a fashion to ensure that the data elements do not correspond to actual real world data elements.

18. The computing system of claim 15, wherein generating the output datasets comprises generating data elements in the output datasets in a fashion to ensure a predetermined amount of inconsistent data is included in the datasets.

19. The computing system of claim 15, wherein the unique identifiers comprise student IDs.

20. The computing system of claim 15, wherein the unique identifiers comprise a time stamp.
